(19) United States
(12) Patent Application Publication
(10) Pub. No.: US 2023/0222422 A1
(43) Pub. Date: Jul. 13, 2023

(54) SYSTEM AND METHOD FOR TRAVEL ASSISTANCE

(71) Applicant: ALLSTATE INSURANCE COMPANY, Northbrook, IL (US)

(72) Inventors: Howard Hayes, Glencoe, IL (US); Jared Li, Northbrook, IL (US)

(21) Appl. No.: 17/574,255

(22) Filed: Jan. 12, 2022

(51) Int. Cl. G06Q 10/06; G06Q 50/30; H04W 4/029; H04W 4/40; H04W 4/024; G08G 1/00; G01C 21/34

(52) U.S. Cl. CPC G06Q 10/0635; G06Q 50/30; H04W 4/029; H04W 4/40; H04W 4/024; G08G 1/202; G01C 21/34

(57) ABSTRACT

Implementations include providing travel assistance services via a mobile device to dispatch a travel assistance vehicle to a user and transport the user to a safe destination. For example, a user of the travel assistance system may desire to be removed from a potentially dangerous situation, such as when traveling internationally in which the user may be unable to contact the authorities directly. The travel assistance system may be accessed by the mobile device in response to a situation for which a user may request a type of travel assistance response, such as a travel assistance vehicle or instructions on navigating a potentially unsafe situation. A travel assistance response may be provided based on information obtained from the mobile device, secondary information from databases, and/or a user profile. A risk assessment of the situation may be calculated by the system to determine the travel assistance response.

### TECHNICAL FIELD

Aspects of the present disclosure generally relate to systems and methods for travel assistance and other enhanced services using a mobile device, and more specifically for wireless-enabled devices that communicate with a remote server computer to provide an optimized trip experience customized to one or more particular individuals and/or travel needs.

### BACKGROUND

Traveling, particularly to international destinations, may involve various unforeseen events and conditions. For example, a traveler to a foreign country may get caught in a natural disaster or may suffer an injury and have little understanding on how to receive services from the local authorities. In some cases, the traveler may not speak the local language to request such services. In other examples, a traveler may be the victim of a crime, may get lost in unfamiliar areas, or may lose a passport and may not be able to locate an embassy to replace the lost passport. In some cases, unforeseen events and conditions may occur close to home. For example, a child may be at sports practice that is cancelled early due to weather, with the child's ride being unable to arrive early and the child needing a ride home.

It is with these observations in mind, among other, that aspects of the present disclosure were conceived.

### SUMMARY

implementations described and claimed herein address the forgoing by providing systems and methods for travel assistance. In one implementation, a method may include the operations of receiving, at a travel assistance system and from a mobile device, a request for a travel assistance response from the travel assistance system, the request comprising a geographic location of the mobile device, obtaining, from one or more databases, secondary data associated with the geographic location of the mobile device and demographic data of a user of the mobile device, and calculating, based on the secondary data, a risk assessment score. The method may also include the operations of determining, based on the risk assessment score, a type of travel assistance response and transmitting one or more instructions, to a computing device in communication with the travel assistance system and corresponding to the type of travel assistance response, the one or more instructions causing the computing device to execute the type of the travel assistance response. Other embodiments of the travel assistance system may include assistance such as providing aid or information to the mobile device, contacting or otherwise alerting one or more authorities (such as law enforcement, ambulance, paramedics, etc.), transmitting one or more directions, routes, and/or alerts to an application of the mobile device to direct a user to a particular location, such as a hotel, hospital, embassy, etc., instructions on how to dress a wound, instructions concerning repairing an inoperable vehicle, mental health checks, contact information for local authorities, and the like.

In another implementation, a travel assistance system comprising a processing device in communication with a network and receiving a request for a travel assistance response from a mobile device, the request for the travel assistance response comprising at least a geographic location and an identifier of a user of the mobile device and a non-transitory database for storing one or more user profiles associated with users of the travel assistance system is described. When the processing device executes one or more instructions that cause the processing device to perform the operations of obtaining, from one or more third-party databases, secondary data associated with the geographic location of the mobile device and calculating, based on the geographic location and the secondary data associated with the geographic location of the mobile device obtained from one or more third-party databases, a risk assessment score and a type of travel assistance response. The one or more instructions may cause the processing device to further perform the operations of determining, based on the risk assessment score and the type of travel assistance response, a type of travel assistance vehicle for responding to the travel assistance response and transmitting one or more instructions, to a computing device of a travel assistance vehicle corresponding to the type of travel assistance vehicle, to dispatch the travel assistance vehicle to the geographic location of the mobile device, the one or more instructions comprising a route to the geographic location.

In another implementation, one or more tangible non-transitory computer-readable storage media storing computer-executable instructions for performing a computer process on a server of a network is described. The computer process may comprise the method of receiving, at the server and from a mobile device, a request for a travel assistance response from a travel assistance system, the request comprising a geographic location of the mobile device, obtaining, from one or more third-party databases, secondary data associated with the geographic location of the mobile device, and calculating, based on the secondary data associated with the geographic location of the mobile device, a risk assessment score for the travel assistance response. The computer process on the server of the network may further comprise determining, based on the risk assessment score, a type of travel assistance vehicle for responding to the travel assistance response and transmitting one or more instructions, to a computing device of a travel assistance vehicle corresponding to the type of travel assistance vehicle, to dispatch the travel assistance vehicle to the geographic location of the mobile device, the one or more instructions comprising a route to the geographic location.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINCIS

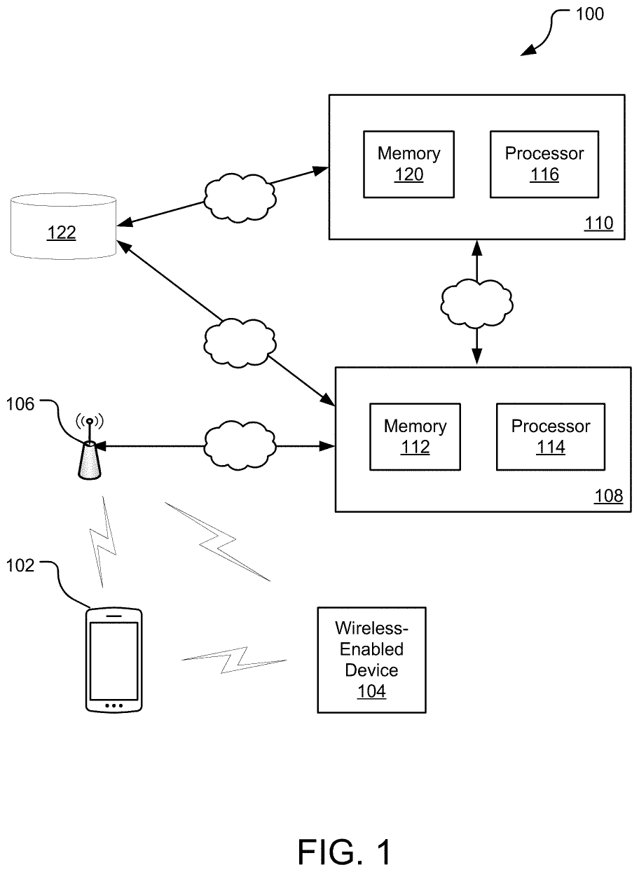

FIG. 1 depicts an illustrative operating environment for providing travel assistance.

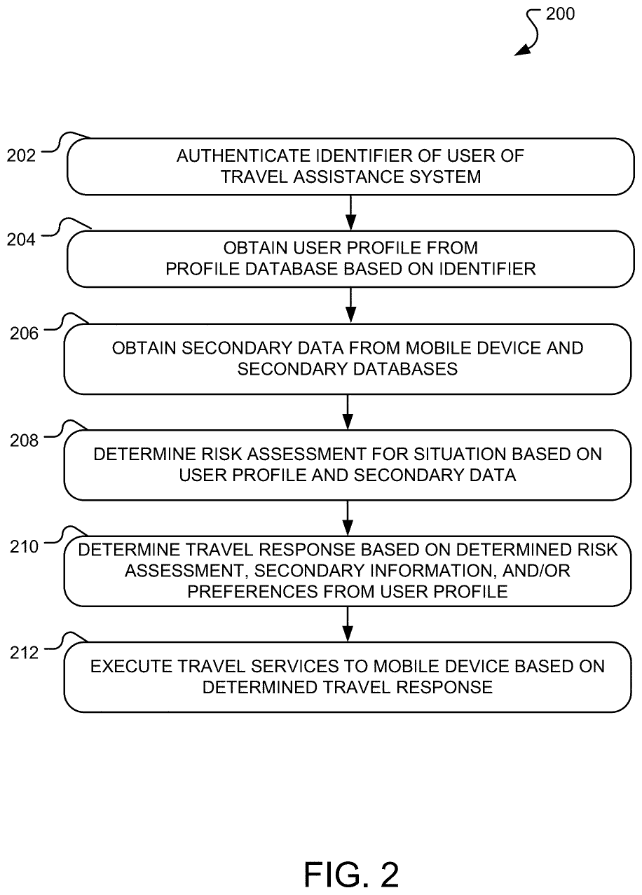

FIG. 2 is a flowchart illustrating an example method for a travel assistance system to dispatch a vehicle to a user in response to an event.

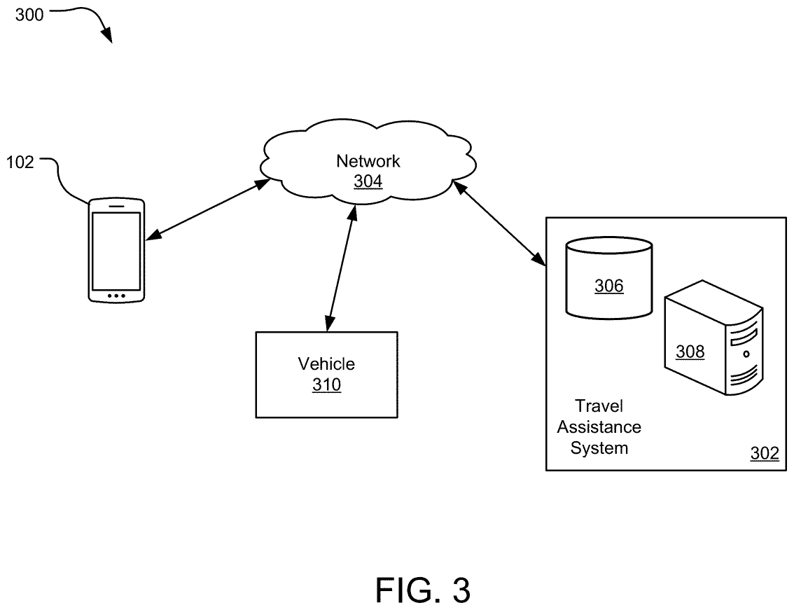

FIG. 3 depicts an illustrative travel assistance system for dispatching a vehicle to a user.

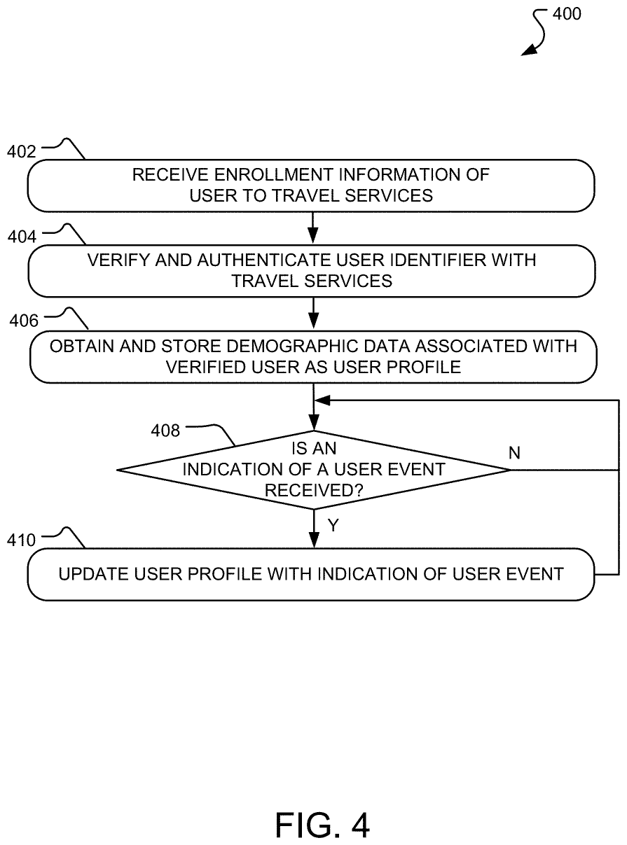

FIG. 4 is a flowchart illustrating an example method for maintaining and updating a database of profiles for a travel assistance system.

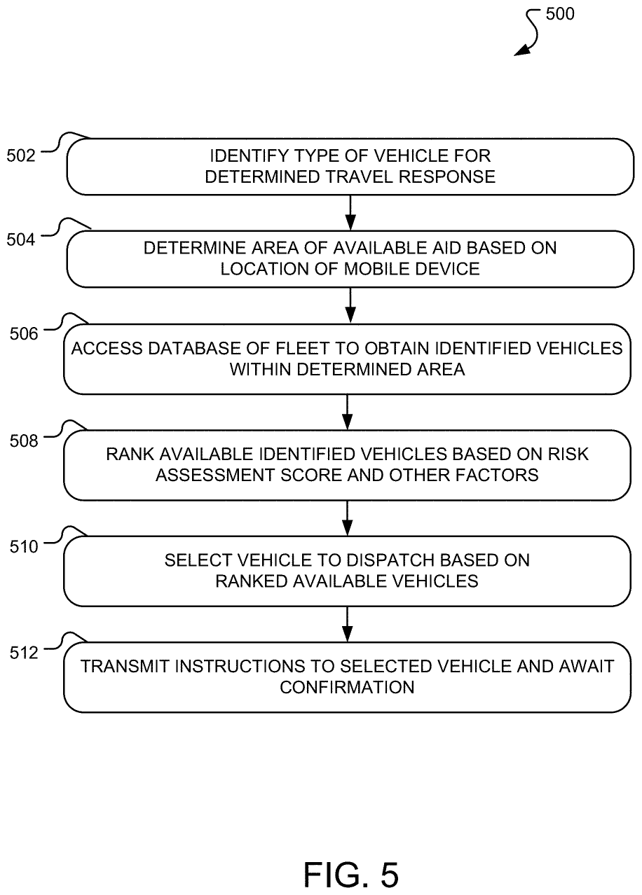

FIG. 5 is a flowchart illustrating a method for selecting a vehicle from a fleet of vehicles for dispatching in response to an event.

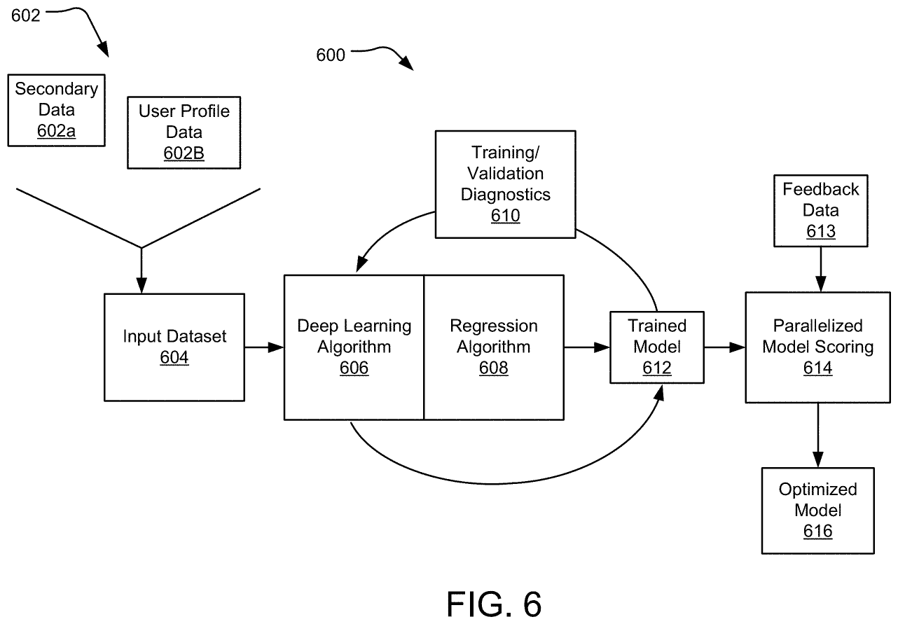

FIG. 6 depicts an illustrative data flow of a machine learning system for determining a travel response to an unforeseen situation.

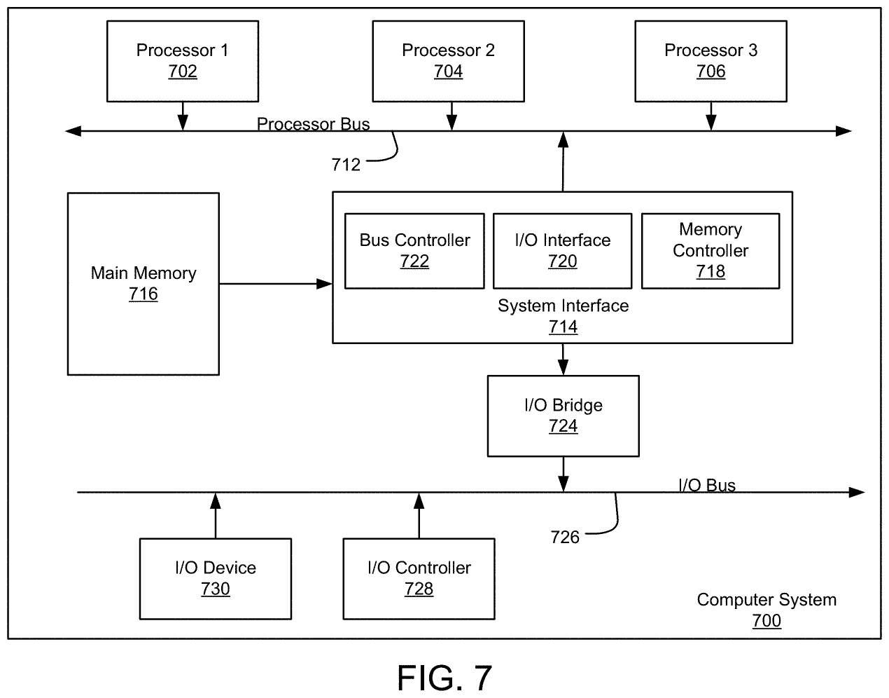

FIG. 7 shows an example computing system that may implement various systems and methods discussed herein in accordance with aspects of the disclosure.

### DETAILED DESCRIPTION

FIG. 1 depicts an illustrative operating environment 100 in accordance with aspects of the disclosure. In one implementation, a user of wireless-enabled devices 102, 104 may communicate with a wireless access point 106. The wireless-enabled device 102 may be a mobile telephone with applications and other functionality, a handheld device with connectivity, a mobile telephone with travel assistance application installed, or other portable electronic device. The wireless-enabled devices 102, 104 may be configured to communicate with a wireless access point 106 such as a cellular tower operated by a cellular service provider. Alternatively, the wireless access point 106 may be a Wi-Fi-enabled hotspot where the wireless-enabled device 102, 104 may obtain access to the Internet (e.g., to communicate using online chat applications or voice-over-1P applications). One skilled in the art will appreciate that other techniques may be used to allow devices 102, 104 access over a wide area network (WAN).

The data communicated from the user devices 102, 104 may be transmitted to a server 108. The server 108 or other type of computing device may include a memory 112 storing computer-readable instructions and a processor 114 for executing the computer-readable instructions. The data communicated to the server 108 from the user device 102, 104 may be transmitted over the WAN through wireless access point 106. Meanwhile, another server 110 may be comprised of a memory 120 storing computer-readable instructions and a processor 116 for executing the computer-readable instructions in accordance with aspects of the disclosure. The memories 112, 120 may also store computer data files that hold information that may be useful to applications running on the user's mobile device 102, 104 or the servers 108, 110. For example, the computer data files may include user login/profile information, insurance policy (or motor club) information; service provider list and related information, and/or other information. The data collected and stored in the data files may be used to support one or more of the numerous features disclosed throughout this disclosure. Both or either first server 108 or another server 110 may store and access data through data store 122, accessible through a network connection.

One skilled in the art will appreciate that the server (e.g.; servers 110 and 108) is not limited to a single machine or device. The server may be embodied as a web server or Internet-accessible server. Furthermore, the term server refers to any system of computers and/or devices (e.g., firewalls, routers, caching systems, proxy servers, etc. or combination thereof) that may be used to provide access to services and features available for use. As such, different reference to the server performing particular steps does not require that the same machine/device perform all the steps.

Servers (108 and 110), data store 122, and wireless access point 106 may communicate over a wired and/or wireless connection. In some instances, a private, secure connection may be established between one or more of these components. For example, server 108 and server 110 may communicate over a network cloud representing the Internet. Alternatively, server 108 and data store 122 may communicate over a secure WAN or a dedicated T1 (or other telecommunications) line. Furthermore, wireless devices 102, 104 may include a processor, memory, display screen (e.g., touchscreen), keypad, sensors (e.g., motion, light, etc.), camera, global positioning system (GPS) chip, audio output/input devices, and other electronic components configured for use in mobile phones, PDAs, and mini-laptops.

Such a server may operate in a networked environment supporting connections to one or more remote computing devices. The remote computing devices may be personal computing devices or servers that include many or all of the elements described below relative to the server. Remote computing devices may be a mobile device communicating over wireless carrier channel. The network connections depicted in the figures may include a local area network (LAN) and/or a wide area network (WAN), but may also include other networks. When used in a LAN networking environment, the server may be connected to the LAN through a network interface or adapter in the communications module. When used in a WAN networking environment, the server may include a modem in the communications module or other means for establishing communications over the WAN, such as the Internet. Multiple instances of the servers 110, 108 may be located at sites around the world to reduce the transmission distance of communications between the servers and the mobile device 102. It will be appreciated that the network connections shown and described are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various commonly known web browsers can be used to display and manipulate data on web pages.

FIG. 2 is a flowchart illustrating a method 200 for a travel assistance system to dispatch a travel assistance vehicle to a user in response to a travel assistance event in accordance with aspects of the disclosure. The travel assistance system may include one or more of the network environment 100 of FIG. 1. For example, a user may utilize mobile device 102 to access server 108 and/or server 110 through a wireless network connect. Servers 108, 110 may execute software or other applications stored in the respective memory devices 112, 120 to perform one or more of the operations of the method 200 of FIG. 2. Additional components of environment 100 or other devices, such as wirelessly-enabled vehicles and additional mobile devices, that may be utilized for execution are discussed in more detail below.

In general, the travel assistance system may be hosted on any number of computing devices within a network or any number of networks. In one particular implementation, the travel assistance system may be a virtual machine, the components of which may be hosted on and executed by any number of networking devices, such as servers 108, 110. Alternatively, the travel assistance system may be hosted on a single server 108, 110 accessible through a network connection. The servers 108, 110 may be included in various computing environments or networks, as well. For example, a server hosting the travel assistance system may be included in a private network of computing devices operated or controlled by a network administrator. In another embodiment, the server hosting the travel assistance system may be included in a public network, such as a public cloud computing environment. Access to the travel assistance system may be provided through one or more public networks (such as the Internet, a wireless mobile network, etc.) or one or more private networks. In one particular implementation, various mobile computing devices, such as a mobile phone, personal digital assistant (PDA), autonomous or non-autonomous vehicles, Global Positioning System (GPS) devices, laptop computers, and the like, may communicate with the travel assistance system through any wired or wireless network connections.

At operation 202, the travel assistance system 302 may authenticate an identifier of a user of the system. In one implementation, the travel assistance system may receive an identifier of the user from a computing device operated by the user, such as a mobile phone or other mobile device. For example, FIG. 3 depicts an illustrative travel assistance system 302 for dispatching a travel assistance vehicle 310 or implement some other type of travel assistance response to a user associated with a mobile device 102 in accordance with aspects of the disclosure. The travel assistance system 302 may, in some implementations, be instantiated in server 110 and/or server 108 of FIG. 1. As such the travel assistance system 302 may include a database 306 or memory and a processor 308 or other type of computing device for executing one or more of the operations discussed herein. The travel assistance system 302 may communicate with the mobile device 102 via a network 304, portions of which may be a wired or wireless network, as described above.

In one example, the mobile device 102 may transmit a user identifier to the travel assistance system 302 through network 304. The mobile device 102 may transmit the user identifier to the travel assistance system 302 through a variety of techniques. For example, the mobile device 102 may launch and execute an application through which a user of the mobile device may provide identifying information, such as a user identifier and/or a password. Such information may be encoded by the application or mobile device 102 and transmitted to the travel assistance system 302. In another example, the mobile device may access the identifying information from a storage device of the mobile device 102, such as a fingerprint identifier or passcode associated with the user of the mobile device. In yet another example, the mobile device may store a unique identifier of the device that may be received at and utilized by the travel assistance system 302 as the user identifier for the assistance system.

The travel assistance system 302 may receive the user identifier from the mobile device 102 and authenticate the user with the travel assistance system. Authentication of the identifier may occur through a comparison of the identifier with a database of approved or registered users of the travel assistance system 302. For example, the database 306 of the travel assistance system 302 may store a list of registered identifiers of the travel assistance system 302. The received identifier may be compared to the list of registered identifiers and authentication of the identifier may occur upon a match with a registered identifier, whether the identifier is a username/password combination or a unique identifier associated with the mobile device 102.

At operation 204, the travel assistance system 302 may obtain a user profile from a profile database based on the received and authenticated identifier. In one implementation, the database 306 may store one or more user profiles associated with a registered identifier. The obtained user profile may include data and/or information associated with user demographics, user preferences, and/or a history of events or actions taken by the travel assistance system 302 that is associated with the identifier. In general, any information associated with the received identifier may be included in the obtained user profile and used by the travel assistance system 302 to generate a travel assistance response.

FIG. 4 illustrates one particular implementation of a method 400 for storing, maintaining, and/or updating a database of profiles for a travel assistance system 302 in accordance with aspects of the disclosure. The travel assistance system 302 may store one or more user profiles in database 306 which may be local to the travel assistance system or may be located remotely from the system. Initially, the travel assistance system 302 may receive enrollment information for a registered user of the travel assistance system at operation 402. The enrollment information may include the user identifier discussed above, such as a username, password, computing device identifier, network address associated with a user device, contact information, and/or any other information that may be used to identify a user of the travel assistance system. The enrollment information may also be provided to the travel assistance system 302 via a third-party. In one particular implementation, a travel assistance service may be provided to members of a group or customers of a company, such as customers to an insurance company. The members or customers of the company, upon purchasing the travel assistance service or another service offered by the company, may be enrolled with the travel assistance system 302 as a service being provided by that company to its members. The third-party company may obtain the identifying information of its members, either during an initial enrollment period or after, and provide some or all of the information obtained by the company to the travel assistance system 302 to enroll the members with the service.

At operation 404, the travel assistance system 302 may verify and authenticate a received user identifier with the system. For example, the travel assistance system 302 may analyze the received enrollment information to determine if a unique identifier of a user is included in the enrollment information. In another example, the travel assistance system 302 may compare the enrollment information against one or more third-party databases to determine if a user associated with the enrollment information is verified to receive travel assistance services from the system. The third-party database may be maintained by a company or organization for which the travel assistance services are offered to members or customers. Thus, the travel assistance system 302 may compare the enrollment information, such as a name of a member or customer, a customer or member identification number, and the like, against a database of member or customer information to verify that the enrollee in the travel assistance system is a valid user. Upon validation of the enrollee, the travel assistance system 302 may generate and store a unique user identifier for the validated enrollee. In some instances, the travel assistance system 302 may utilize a value included in the enrollment information, such as a name of a user, user identification number, a group name, etc., as the user identifier for the enrollee. In another example, the travel assistance system 302 may generate and assign a user identifier to the enrollee, either based on the received enrollment information or from a random generating user identification technique. In any case, the travel assistance system 302 may provide the user identifier to the enrollee for use in accessing the travel assistance system. The travel assistance system 302 may also store the generated user identifier in the database 306, along with any portions of the enrollment information associated with the user.

At operation 406, the travel assistance system 302 may obtain and store demographic data or any other data associated with the verified user of the system. Such information may be obtained from the enrollment information or from a separate database of user information. For example, the travel assistance system 302 may obtain such information as a name of the user, an age of the user, identifiers of family members of the user, demographic information of the identified family members, historical interactions with a company or system providing an associated service to the user, geographic information of the user (such as home address, work address, frequent travel routes obtained from one or more GPS systems), historical travel information (such as travel destinations, frequency of travel, international versus international trips, mode of travel, etc.), or any other information that may aid the travel assistance system in customizing a travel assistance response to the user. A third-party company, such as an insurance company through which the travel assistance service may be offered, may obtain and store such demographic information of the user and provide said information to the travel assistance system 302. Information pertaining to the user as a customer to the company may also be provided, such as interactions with other services provided by the company, an active or inactive status of the user with the company, payment history of the user with the company, and the like. The demographic information obtained by the travel assistance system 302 may, along with the user identifier, enrollment information, or any other information associated with the user, may be stored in database 306 as a user profile.

Over time, certain events may occur that may be added to the user profile to update the profile with new information. For example, the user associated with a particular user profile may add a family member such that the user profile may be updated to include the new family member. In another example, the user may access a service offered to the user, such as a travel assistance service discussed in more detail below. Information associated with the interaction of the user with the service may be obtained and added to the user profile, such as date and time of event, location of event, nature of event, service provided to user, communications with user concerning the event, and the like. In yet another example, interactions the user has with a company offering the travel assistance service may also be included in the user profile, such as changes to a requested coverage of services to the user, failure to make a monthly payment for requested services, increases or decreases in requested and provided services or monthly fees, and the like. Changes to devices associated with the user may also be obtained and stored, such as addition or deletion of mobile devices 102 associated with the user, new or deleted telephone numbers associated with a mobile device, updates to passwords and usernames, etc. In general, any interaction the user may have with the travel assistance system 302 and/or a company or organization associated with the travel assistance system may be considered as a user event for inclusion in the user profile.

As such, at operation 408, the travel assistance system 302 may determine if an indication of a user event is received and, if not, may continue to monitor for new indicators of user events. Not all indicators of a user event may be included in an associated user profile. For example, events not associated with a travel assistance service may not be stored. However, indicators of any event that may aid in determining a travel assistance response may be added to the user profile at operation 410. In this manner, the user profile may continue to be updated with new user events over time such that additional information concerning the user may be obtained and stored in the database 306 as associated with the user profile. Upon updating of the user profile, the travel assistance system 302 may return to operation 408 to continue monitoring for updates to the user profile.

In general, the travel assistance system 302 may provide a travel assistance service to authenticated users based at least on the user profile or other information associated with the user. In one particular example, a user of the travel assistance system 302 may desire to be removed from a potentially dangerous situation, such as when traveling internationally or other location in which the user may be unable to contact the authorities directly or a friend for help. In such circumstances, the travel assistance system 302 may be accessed by the mobile device 102 in response to a situation for which a user may request a type of travel assistance response. For example, the user may be traveling internationally and become lost, unable to make it back to a hotel. In another example, the user may become injured while traveling and be unaware of the proper entities to contact to obtain medical services and/or may not be able to speak the local language to order such services. In still another example, the user may be traveling internationally and may be misplaced their passport, requiring transportation to the embassy to obtain a new passport. The travel assistance system 302 may also be utilized in non-traveling situations. For example, a parent of a child may not be able to pick up the child from school or practice, perhaps due to an unexpected circumstance such as inclement weather, disabled vehicle, or a change of plans. In another example, a user may begin to feel unsafe in a particular neighborhood or location, may feel as though they are being followed, may be caught in a protest or other civil unrest, and the like. The travel assistance system may further be used in a rescue circumstance in which a user of the mobile device 102 may desire to be removed from the circumstance and taken to another location.

Regardless of the circumstance, a user may utilize the mobile device 102 as described above to access the travel assistance system 302 to request some type of travel assistance service for themselves or for some other person. The travel assistance service may take many forms, such as dispatching an autonomous or non-autonomous vehicle to the user's location to gather the user or other party and remove them from a potentially dangerous situation. In another example, the vehicle may be dispatched to take the user or other persons to a particular destination, such as a hospital, an embassy, a user's hotel, a user's home, or any other different location that may be a more safe environment for the user. In still another example, the vehicle dispatched by the travel assistance system 302 may include police personnel, fire-fighting personnel, medical personnel, other security personnel, and the like. Other travel assistance service responses are discussed in more detail below to provide the requested travel assistance to the user or other persons based on the access to the travel assistance system 302.

Returning to the method 200 of FIG. 2, the travel assistance system 302 may obtain the user profile from the database 306 based on the user identifier received from the mobile device 102. As described above, the user identifier may be provided by the mobile device 102 in response to the user accessing a mobile application executed on the device to communicate with the travel assistance system 302. In another example, the mobile device 102 may determine that a user of the device 102 may require a travel assistance service and may launch the associated application on the user's mobile device 102. The application may then prompt the user, through the interface of the mobile device 102, if a travel assistance service by the travel assistance system 302 is needed or requested, upon which the user identifier may be transmitted to the travel assistance system. The mobile device 102 may launch the application based on any information or data obtained by the mobile device, such as geographic location data, weather or climate information, emergency notifications, and the like.

Through the user profile obtained by the travel assistance system 302 in response to receiving the user identifier, the travel assistance system may determine information associated with the user of the mobile device 102. For example, the travel assistance system 302 may determine a user's name, family members associated with the user, travel history of the user, known geographic locations associated with the user (such as home address, work address, known travel destinations, etc.), one or more preferences for travel assistance, and the like. In addition, at operation 206, the travel assistance system 302 may obtain secondary data from the mobile device 102 and/or one or more secondary databases. This secondary information may be any information that aids the travel assistance system 302 in determining if a potentially dangerous situation is occurring, the nature of the potentially dangerous situation, and/or one or more travel assistance responses to the determined dangerous situation. For example, the travel assistance system 302 may request and/or receive geographic location information from the mobile 102, including in some instances a country, a state, a city, latitude and longitude coordinates, other coordinates, and the like. The travel assistance system 302 may also obtain other information about a user from the mobile device 102, such as a detected health condition of the user through one or more wearable devices configured to monitor a health condition of the user, weather conditions at the location of the mobile device 102, safety alerts (associated with the location of the mobile device 102 or not) transmitted to the mobile device 102 from a third-party notification service, and the like. In some instances, the secondary information may be obtained from a user of the mobile device 102 through a prompt displayed on the interface of the device. For example, an executed application may display a query requesting additional information of a potentially dangerous situation, such as a type of danger detected by the user, a requested travel assistance (such as being connected to a travel assistance service technician, dispatching a travel assistance vehicle 310, alerting the authorities, etc.), emergency contact information, an identification of a hotel of the user, an identification of a home address of the user, information concerning the party or parties to receive the travel assistance services, and the like. In general, any information obtainable by the mobile device 102, either through one or more executing applications or through inputs provided to the mobile device from a user of the device, that may aid the travel assistance system 302 in determining a travel assistance response may be obtained from the mobile device.

Similarly, additional secondary data or information may be obtained from one or more secondary databases. Secondary databases may include a third-party database that stores data for use in determining a potentially dangerous situation. For example, the travel assistance system 302 may access a database storing weather information associated with the location of the mobile device 102. In another example, the travel assistance system 302 may access a database of crime information, either historical or current, associated with the mobile device 102 location. Other examples of secondary information obtained from one or more secondary databases may include police/fire/medical information for a location of the mobile device 102 (such as contact information, translation services, general information for obtaining aid from such services for foreign travelers), embassy information associated with the nationality of the user, emergency alerts of the location (such as weather emergencies, political unrest, locations of protests, etc.), time of day, time until sundown or sunrise of the mobile device location, and the like. Some secondary databases may be accessible to determine a viability of one or more travel assistance responses. For example, locations of potential travel assistance vehicles 310 may be obtained in relation to the location of the mobile device 102, including estimated arrival times for each of the located potential travel assistance vehicles based on current traffic conditions of the area around the mobile device. Other secondary information associated with potential travel assistance services may include qualifications of drivers of potential travel assistance vehicles 310 (whether the driver or a passenger in the vehicle is trained in providing medical aid, security services, mental health services, working with children, etc.), a rating of the drivers of the potential travel assistance vehicles, capabilities of the potential travel assistance vehicles (such as ambulance supplies, police supplies, bulletproof windows, etc.), demographic information of drivers of the potential travel assistance vehicles (such as sex, age, languages spoken, etc.), and the like. Such secondary information may be used to determine a travel assistance response to the potentially dangerous situation, as described in more detail below.

At operation 208, the travel assistance system 302 may determine a risk assessment for the potentially dangerous situation based on the user profile information and/or the secondary data. In one instance, a location-based risk assessment of the situation may be generated from the information obtained associated with the location of the mobile device 102. Situations with a high potential for risk to a user of the mobile device 102 may be assigned a higher risk assessment. For example, the travel assistance system 302 may determine that a historically high-crime area may have a high-risk location score during nighttime hours. Similarly, a location under a political unrest alert or under a tornado warning may also be assigned a high-risk location score. Conversely, low-crime areas during daylight hours may be assigned a low risk location score. Other secondary information may also be considered for the risk assessment for the location of the mobile device 102. For example, a user of the mobile device 102 may indicate that the user has suffered an injury and needs assistance. Through one or more prompts to the mobile device 102, a severity of the injury may be ascertained and a risk assessment score may be determined, with a high-risk location score assigned to more severe injuries and a low risk location score assigned to minor injuries. In another example, the user may indicate, via the mobile device 102, that the user is lost and needs assistance to return to the user's hotel. A situation in which a user is lost at night may be assigned a higher risk locate score than if the user is lost during the day. In yet another example, an indication of the user being in imminent danger, such as an indication of being followed or chased or being the victim of a currently-occurring crime, may be assigned a high-risk location score by the travel assistance system 302. In still another implementation, the risk assessment score may be based on demographic information or other information of the user and/or family members of the user. For example, an age and sex of the user may be used to determine the risk assessment score. In another example, a number of people within a group associated with the user may be a factor in the risk assessment score, such as if the user is with their entire family or alone.

To assess or determine the risk location score for a given situation, the travel assistance system 302 may assign a relative risk score to each of the secondary data or information obtained from the mobile device 102 or the secondary databases. For example, a location at which over 20 violent crimes has occurred in the last five years may be assigned a high-risk score, while a low crime location with no violent crimes over the same period may be assigned a low risk score. Similarly, a warning of a potential hurricane in a location may be given a high-risk score while a warning of a potential protest in the location may be given a low risk score. In some instances and as described in more detail below, the risk scores for each of the secondary data or information may be learned through a machine learning technique. The travel assistance system 302 may combine the risk scores for each of the bits of data associated with the location of the mobile device 102 from which an average or other combined risk score may be determined. Other risk assessment techniques may also be employed to categorize and quantify a relative risk for a given situation associated with the mobile device 102.

The risk location score for the given situation may be augmented or adjusted based on information or data obtained from the user profile. For example, the user profile may indicate that the user is elderly such that a fall or other type of injury may be more dangerous in comparison to a child with the same injury. The user profile may also indicate the user may be traveling with several small children that may increase the danger in a given situation. In still another example, the user profile may indicate the user does not speak the native language of the current location of the mobile device 102 and may be unable to ask for assistance from a passerby. The user profile may also indicate that the user does not travel internationally often and may be unfamiliar with the available local assistance. In each of the above examples, the travel assistance system 302 may increase the risk assessment score for the given situation based on the information contained in the user profile. In contrast, the travel assistance system 302 may determine, based on the information in the user profile, that the user has visited the current location of the mobile device 102 several times, speaks the local language, or may have received training (such as through the user's employment) that may mitigate a dangerous situation. In such instances, the travel assistance system 302 may lower the risk assessment for the given situation. The travel assistance system 302 may therefore adjust the risk assessment of the given situation according to the information obtained from the user profile.

Similar to above, the travel assistance system 302 may assign a relative risk score to each of the data or information obtained from the user profile. User information that may increase the risk score for a given situation may be assigned a positive risk score, while user information that mitigates a dangerous situation may be assigned a negative risk score. Also similar to above, the risk scores for each of the user information of the user profile may be learned through a machine learning technique. The travel assistance system 302 may combine the risk scores for each of the bits of data associated with the user profile from which an average or other combined risk score may be determined. In situations in which the user information results in a negative risk score, the travel assistance system 302 may lower the overall risk assessment for the situation by the determined risk score of the user profile. Additional risk factors obtained from the user profile may otherwise raise the risk score for the given situation to result in an overall risk assessment score for the situation based on the user profile information and secondary information obtained from the mobile device 102 and/or the secondary databases.

At operation 210, the travel assistance system 302 may determine a travel assistance response based on the determined risk assessment, the secondary information, and/or the user preferences included in the user profile. For example, the risk assessment or risk score attributed to a given situation may indicate a travel assistance vehicle 310 should be dispatched immediately to the mobile device 102 location and should include medical aid, such as a situation that is determined to include a high-risk to a user and involve a medical emergency. Another assessment may indicate that the user is at a high-risk for being the victim of a violent crime such that dispatching a security vehicle to the mobile device 102 quickly is the determined travel assistance response. For low risk assessed situations, the determined travel assistance response may include dispatching a vehicle to the mobile device 102 location at a lower priority, such as through selection of a vehicle that is further from the mobile device location if closer vehicles are needed for other emergencies or rescue situations. The determined travel assistance response may include a determination of a type of vehicle to dispatch, a determination of a type of driver of the vehicle, how quickly the aid should arrive at the mobile device location, whether a travel assistance vehicle 310 should be dispatched, establishing a communication with a user through the mobile device (such as through a video conference displayed on the mobile device), establishing a communication with a user of the mobile device through the dispatched vehicle, providing directions to the mobile device via one or more applications, and the like.

The determined travel assistance response may further be based on one or more preferences obtained from the user profile. Preferences for a user profile may be obtained during enrollment of a user with the travel assistance system 302 or as an event following enrollment that updates the profile with the preference. A preference may be an indication of any aspect of a travel assistance response that is preferred by the user associated with the user profile. For example, the user profile may include a preference for immediate dispatch of a travel assistance vehicle 310 upon request, regardless of the risk assessment score assigned to a particular situation. Such a preference may be made available to a user of the travel assistance system 302 for an additional cost to the user, in some instances. Another preference may indicate a rescue worker to first contact the user via the mobile device 102 for any request for aid from the user before a travel assistance vehicle 310 may be dispatched. In another preference, a particular gender of a driver of a travel assistance vehicle 310 may be indicated. In still another preference, an autonomous vehicle may be preferred over a non-autonomous vehicle. In general, any aspect of the travel assistance response may have an associated preference for selection or indication by a user of the travel assistance system 302 and for storage in the user profile.

Although the user profile may include one or more preferences for a travel assistance response, the determined travel assistance response may or may not abide by the indicated preference. Rather, the travel assistance system 302 may weigh the user preferences against other aspects of the determined travel assistance response, such as the risk assessment score for the analyzed situation. In one example, the user may indicate a preference for autonomous vehicles to be dispatched in the event a travel assistance response including a vehicle is determined. However, the mobile device 102 may be located in a country or area in which autonomous vehicles are not available for dispatch. In such a situation, the user preference may be overridden and a manned vehicle may be dispatched by the travel assistance system 302. In another example, a user preference may indicate a direct communication with a user of the mobile device 102 prior to dispatch of a travel assistance vehicle 310. However, the risk assessment for the situation may determine that the user may not be available to communicate via the mobile device 102, such as in a situation in which the user may be injured. Secondary information from a wearable device may indicate to the travel assistance system 302 that the user is unconscious and unable to communicate. In such a situation, the user preference for a communication via the mobile device 102 prior to dispatch of a travel assistance vehicle 310 may be overridden and the vehicle, with the proper medical aid for the user, may be dispatched by the travel assistance system 302. Thus, the travel assistance system 302 may weigh user preference against the determined urgency of the dangerous situation to ascertain if the travel assistance response should follow the user preference.

At operation 212, the travel assistance system 302 may execute one or more travel assistance services to the mobile device 102 and/or user of the mobile device based on the determined travel assistance response. For example, the travel assistance system 302 may contact a travel assistance vehicle 310 to the location of the mobile device 102. The dispatch of the travel assistance vehicle 310 may include directions to the location of the mobile device 102, a risk assessment of the situation, one or more portions of the secondary information or user profile information (such as a health condition of the user based on a wearable device, weather or safety alerts in the area, identifying information of the user of the mobile device, one or more user preferences, identifying information or contact information for the mobile device), destination location for the user upon travel assistance, contact information for a dispatcher, etc.

To dispatch a travel assistance vehicle 310, the travel assistance system 302 may execute one or more of the operations of the method 500 illustrated in FIG. 5. In particular, the travel assistance system 302 may, at operation 502, identify a type of travel assistance vehicle 310 to dispatch from a fleet of travel assistance vehicles 310 based on the determined travel assistance response. For example, the determined travel assistance response may indicate that a user of the mobile device 102 may require medical services such that the travel assistance system 302 may identify travel assistance vehicles 310 that include some medical supplies or personnel, such as an ambulance, a vehicle with a first aid kit, a vehicle operated by a trained doctor, nurse, or emergency medical technician, and the like. In another example, the determined travel assistance response may indicate that a security vehicle is needed such that the travel assistance system 302 may identify those vehicles that include some security features, such as bulletproof glass, security personnel operating the vehicle, police, etc.

Once a type of travel assistance vehicle 310 is identified based on the determined travel assistance response, the travel assistance system 302 may determine an area of available aid based on the location of the mobile device 102. As discussed above, the location of the mobile device 102 may be provided to the travel assistance system 302 upon the initial request for aid via the mobile device. The travel assistance system 302 may establish an area of available aid for the mobile device 102 based on that location, the determined travel assistance response, and any other information discussed above. For example, a determined high-risk situation may indicate that aid should arrive to the mobile device's location quickly such that the area of available aid may be based on how fast a travel assistance vehicle 310 may arrive. The time it may take for a vehicle to arrive may be determined from one or more conditions of the area around the mobile device 102, such as the prevalence and density of navigable streets, a traffic condition near the mobile device, one or more available routes for vehicles to traverse to arrive at the mobile device location, and the like. For low risk situations, the area of available aid may be larger as the speed at which a travel assistance vehicle 310 arrives may be less important to the safety and well-being of the user of the mobile device 102. In one instance, the area of available aid may be a circle of a particular diameter centered around the location of the mobile device 102.

At operation 506, the travel assistance system 302 may access a database of vehicles of a travel assistance fleet to obtain the presence and/or location of one or more identified vehicles within the area of available aid. In general, each vehicle 310 of the fleet of travel assistance vehicles may register with the travel assistance system 302 and be included in a network of available travel assistance vehicles. Such registration may include vehicle type, services provided by each vehicle, specifications of each vehicle, demographics and specifications of operators and personnel of the vehicle, and the like. The fleet of travel assistance vehicles may also continuously provide a location of the respective vehicle to the travel assistance system 302 when operating as a travel assistance vehicle 310. In some instances, the vehicles of the fleet may include autonomous vehicles that may, as described in more detail below, be requested and/or controlled by the travel assistance system 302 to respond as part of a determined travel assistance response.

The travel assistance system 302 may maintain a database of the fleet of travel assistance vehicles that includes estimated location of one or more vehicles and the capabilities/specifications of the vehicle and/or any operator or personnel. The travel assistance system 302 may, at operation 506, limit the number of potential vehicles obtained to those vehicles within the determined area of available aid and/or the identified type of travel assistance vehicle 310 for the determined travel assistance response. Thus, the travel assistance system 302 may identify those travel assistance vehicles that qualify for the determined travel assistance response and are within the area near the location of the mobile device 102. In another implementation, the travel assistance system 302 may identify all travel assistance vehicles within the determine available area. If no qualifying travel assistance vehicles or other travel assistance vehicles are present within the available area around the mobile phone 102 location, the travel assistance system 302 may return to operation 504 and generate a wider area of available aid.

At operation 508, the travel assistance system 302 may rank the available identified travel assistance vehicles of the determined area based on the risk assessment score for the potentially dangerous situation and other factors. In one example, the travel assistance system 302 may rank the travel assistance vehicles on how fast each vehicle may arrive at the mobile device 102 location based on distance from the location, traffic patterns, congestion, available roads, etc. The travel assistance system 302 may also rank the identified travel assistance vehicles based on the specifications of the vehicle and/or operator of the vehicle corresponding to the determined travel assistance response. For example, the travel assistance system 302 may rank vehicles with medical equipment and/or personnel higher than vehicles without such equipment for a determined medical situation. Ranking of the travel assistance vehicles may also include a user preference, such as ranking autonomous travel assistance vehicles higher for users with a preference for autonomous travel assistance vehicles. In still other implementations, the travel assistance system 302 may combine many factors in ranking the available identified travel assistance vehicles. For example, for situations with a high-risk assessment score, the travel assistance system 302 may prioritize travel assistance vehicles that are closer to the mobile device 102 location than travel assistance vehicles that correspond to a user preference. In another example, a travel assistance vehicle 310 with medical supplies may be ranked higher than closer vehicle if the secondary information indicates that a user may be injured and need medical help. In still another example, a travel assistance vehicle 310 matching a user preference may be ranked higher than other travel assistance vehicles for low risk situations, such as a user needed transportation to a hotel. In general, the travel assistance system 302 may rank the travel assistance vehicles based on any number and type of information either generated by the travel assistance system or obtained from another source, such as the mobile phone 102 or a secondary database.

At operation 510, the travel assistance system 302 may select a travel assistance vehicle for dispatch from the ranked list of available travel assistance vehicles. In some instances, the travel assistance system 302 may select the travel assistance vehicle 310 with the highest ranking of the ranked list. In other instances, the travel assistance system 302 may select a travel assistance vehicle 310 from the ranked list other than the highest ranked vehicle. Such selection may be based on any information or rules, such as one or more business rules or efficiency considerations of the travel assistance system 302. At operation 512, the travel assistance system 302 may transmit one or more instructions to the selected travel assistance vehicle 310 to dispatch the vehicle to the location of the user device 102 or to another location designated by the mobile device (such as when a travel assistance vehicle 310 may be dispatched to pick-up a family member). In one implementation, the travel assistance system 302 may provide instructions to a dispatching system or operator. Such instructions may include any information associated with dispatching the travel assistance vehicle 310 to the mobile device 102 location or other location, such as routing information to reach the destination, information associated with the party to be picked up, verification and validation of the travel assistance request, one or more indications of a reason behind the travel assistance request, safety warnings concerning the pick-up location, details of the determined travel assistance response and user, user preferences, and the like. In general, any information concerning the travel assistance response, including user profile information and/or secondary information, may be provided to the dispatching system or operator for forwarding onto the travel assistance vehicle 310. In another implementation, the travel assistance system 302 may transmit one or more instructions to an autonomous travel assistance vehicle 310 to dispatch the autonomous travel assistance vehicle to the travel assistance location. Such instructions may include the desired destination for the travel assistance vehicle and any other information or data associated with the determined travel assistance response, as noted above. In this manner, one or more travel assistance vehicles, either manned or autonomously controlled, may be dispatched to the travel assistance location (such as the location of the mobile device 102 or another indicated location) for travel assistance. The selected travel assistance vehicle 310 may return a confirmation that it is on route to the travel assistance location. If a confirmation is not received (perhaps after a waiting period), the travel assistance system 302 may return to operation 510 to select another travel assistance vehicle from the ranked list of vehicles and transmit a request to the alternately selected travel assistance vehicle.

Although the travel assistance response discussed herein includes a dispatch of a travel assistance vehicle 310, other responses may be included in the travel assistance response. For example, the travel assistance system 302 may include establishing a communication with the mobile device 102 and providing some information to the mobile device, such as through a text message, video conference, telephone message, and the like. In one instance, a dispatcher may be connected with the mobile device 102 to speak with a user of the mobile device as a portion of the travel assistance response. In another example, the travel assistance system 302 may transmit one or more directions, routes, and/or alerts to an application of the mobile device 102 to direct a user to a particular location, such as a hotel, hospital, embassy, etc. The application of the mobile device 102 may be any application, such as a mapping application, a GPS-interface application, a texting application, and the like. In a similar manner, one or more instructions may be transmitted to an application of the mobile device 102 from the travel assistance system 302, such as instructions on how to dress a wound, instructions concerning repairing an inoperable vehicle, mental health checks, contact information for local authorities, and the like.

In still another instance, the travel assistance response may include the travel assistance system 302 communicating with a communication device within the travel assistance vehicle 310. For example, the travel assistance vehicle may include a mobile device or video conferencing device through which a dispatcher or other rescue personnel may communicate with a user of the travel assistance system 302 once the user has entered the vehicle. Communications between the travel assistance system 302 and the user may occur to verify the identity of the user, provide instructions to the user as described above, comfort the user, obtain a destination for the travel assistance vehicle 310, or any other information that may aid the travel assistance system 302 and/or travel assistance vehicle in providing the determined travel assistance response. In one particular example, a video communication system may be included in the travel assistance vehicle that may request a user entering the vehicle to provide some identifying information, such as the user identifier discussed above. The verification information may be transmitted to the travel assistance system 302 and correlated with the travel assistance request. Upon verification, the video communication system may connect to a dispatcher of the travel assistance system 302 and a communication session may occur between the dispatcher and the user, including providing a mental health check on the user. The type of communication, qualifications of the dispatcher, instructions generated and transmitted, requirement of user verification, and other information exchanges between the travel assistance system 302 and the mobile device 102 and/or travel assistance vehicle 310 may be based on any of the information discussed above, including the user profile, secondary information, and/or user preferences.

As mentioned above, the travel assistance system 302 may utilize one or more machine learning techniques to determine a travel assistance response based on the secondary information received from the mobile device 102 and secondary databases and/or the information obtained from the user profile. FIG. 6 depicts an illustrative data flow 600 of a machine learning system for determining a travel assistance response to a potentially dangerous situation. Through the data flow 600, a travel assistance response model may be generated from previously generated travel assistance responses to aid the travel assistance system 302 in determining a travel assistance response with little or no input from a user of the mobile device 102. Rather, machine learning, artificial intelligence, and other algorithms or techniques may be trained through an iterative validation process to process the secondary data and user profile to automatically determine a travel assistance response.

The data flow 600 may include generating an input dataset 604 for input to a deep learning system 606. The dataset 604 may include any of the input information or data discussed above, such as secondary information received from the mobile device 102, secondary information received from one or more secondary databases, data from a user profile associated with a travel assistance request, and the like. The number and types of data 602 included in the input dataset 604 may vary from model to model such that no particular type of data 602 is required to generate the travel assistance response model. Rather, any datasets may be supplied as input to the deep learning machine 606, although additional data may result in a more detailed travel assistance response model.

The deep learning machine 606 may iteratively train multiple models, based on the provided dataset 604, to determine a combination of model parameters for particular travel assistance responses. For example, the deep learning machine 606 may utilize one or more algorithms to correlate portions of the input dataset 604 with various generated response models and, through a regression algorithm 608, may train/validate the various generated models with the input dataset 604. In one implementation, training/validation diagnostics 610 may be applied to each generated travel assistance response model to determine an accuracy of the model to the input datasets 604. Through a determined error obtained from the application of the various models to the training/validation diagnostics 610, the deep learning machine 606 may determine how accurate or how closely the generated model corresponds to the input dataset 604. The deep learning machine 606 may then alter the generated travel assistance response model based on the determined error to address and attempt to eliminate the error. This process of model generation, regression, validation, and alteration may be repeated until the determined error of the travel assistance response model (as based on the validation diagnostics 610) falls below a threshold value. In another example, the deep learning machine 606 or a user of the deep learning machine may pick a subset of “training inputs” and “validation inputs” based on labels, targets, prioritized areas, and the like. There is no fixed or set method for number of inputs for training and number of validations. Distributed inputs and validation provide better results and prevents either trained model or validation from being biased to one feature or section of the data. Training and validation data may be changed manually or iteratively to further improve models and remove bias.

Through the data flow 600, the deep learning machine 606 may generate multiple travel assistance response models that each perform within the thresholds of the validation diagnostics. However, some travel assistance response models generated by the deep learning machine 606 may be more accurate than others. To determine the optimal model generated by the system, each trained model 612 may be applied to a model scoring 614 technique. In particular, each trained model 612 may be compared to feedback data 613 from one or more executed travel assistance responses to determine an accuracy score for the generated trained models 612. A comparison of the expected travel assistance response to the actual travel assistance response may be performed at the parallelized model scoring 614 of the system. The trained model 612 with the lowest delta between the expected travel assistance response to the actual travel assistance may be considered the optimized travel assistance response model 616. This optimized model 216 may be used by the travel assistance system 302 to process new input datasets and predict an optimal travel assistance response based on the new input datasets. The travel assistance response may then be executed without requiring additional information from the mobile device 102 such that an optimal response may be generated based on the obtained information from the mobile device and/or the secondary sources.

Through the optimized model, a user may request a travel assistance or other aid through the mobile device 102 and the travel assistance system 302 may generate the travel assistance response automatically without needed multiple inputs from the user of the device. In particular, the travel assistance system 302 may obtain secondary information from the secondary sources and the user profile and apply that data as an input dataset to the optimized model 616. The optimized model 616 may then output an estimated travel assistance response for the user based on the input datasets and automatically execute the travel assistance response, such as dispatching a travel assistance vehicle and/or contacting the mobile device 102 to aid the user. In some instances, the optimized model 616 may be customized to the user of the system or may be a global travel assistance response model for the travel assistance system 302. Further, the optimized model 616 may be updated and refined as more and more travel assistance responses are processed through the travel assistance system 302.

Through the methods and systems described above, a user of the travel assistance system 302 may request aid in response to a potentially dangerous situation. In one example, a user may be traveling internationally and may become lost at night attempting to walk back to the user's hotel. The user may launch the travel assistance application on the mobile device 102 and request aid in returning to the user's hotel. The travel assistance system 302 may receive the request from the mobile device 102 and access a user profile associated with the device or the user and one or more secondary databases to obtain an understanding of the conditions surrounding the mobile device, such as type of neighborhood, weather conditions, stability, and the like. Based on the obtained information, the travel assistance system 302 may determine that a travel assistance vehicle matching a preference of the user contained in the user profile may be dispatched to pick up the user and deliver the user to the hotel. The travel assistance system 302 may generate one or more instructions to dispatch the travel assistance vehicle to the mobile device 102 location. Upon entering the travel assistance vehicle, a video screen may display a dispatcher avatar to request the user's unique identifier. Upon verification with the travel assistance system 302, the travel assistance vehicle may deliver the user to the designated hotel safely.

In another example, a child of a user of the travel assistance system 302 may be stranded at school when a scheduled bus does not arrive on time to take the child home. The parent user may access the travel assistance application via the mobile device 102 and request a travel assistance vehicle be dispatched to pick up the child from the school. The travel assistance system 302 may receive the request and the school location, based on the user profile associated with the device or the user and one or more secondary databases, determine a type of travel assistance response, including an urgency for the travel assistance vehicle to arrive and if any additional services may be needed. In one example, the travel assistance system 302 may determine from the secondary data that there is inclement weather at the school such that the child may be in danger if left outside for too long. The travel assistance system 302 may decide on a travel assistance response that may include contacting the child through a second mobile device carried by the child to inform them that a vehicle is on its way and to stay with the child until the travel assistance vehicle arrives. Upon arrival, the dispatcher speaking with the child through the second mobile device may provide instructions to the child on interacting with the travel assistance vehicle, such as a driver's name, provide a picture of the driver, and to monitor the location of the travel assistance vehicle. Upon entry into the vehicle, the dispatcher communication may switch to an in-vehicle communication device to guide the child through the transport to the home address of the user. As should be appreciated, the above are merely examples of the travel assistance system 302 operations and many variations in the operations and determined travel assistance response may be executed by the travel assistance system.

FIG. 7 is a block diagram illustrating an example of a computing device or computer system 700 which may be used in implementing the embodiments of the components of the network disclosed above. For example, the computing system 700 of FIG. 7 may be the mobile device 102 or one or more of the servers 308 of the travel assistance system 302 discussed above. The computer system (system) includes one or more processors 702-706. Processors 702-706 may include one or more internal levels of cache (not shown) and a bus controller or bus interface unit to direct interaction with the processor bus 712. Processor bus 712, also known as the host bus or the front side bus, may be used to couple the processors 702-706 with the system interface 714. System interface 714 may be connected to the processor bus 712 to interface other components of the system 700 with the processor bus 712. For example, system interface 714 may include a memory controller 718 for interfacing a main memory 716 with the processor bus 712. The main memory 716 typically includes one or more memory cards and a control circuit (not shown). System interface 714 may also include an input/output (I/O) interface 720 to interface one or more I/O bridges or I/O devices with the processor bus 712. One or more I/O controllers and/or I/O devices may be connected with the I/O bus 726, such as I/O controller 728 and I/O device 730, as illustrated.

I/O device 730 may also include an input device (not shown), such as an alphanumeric input device, including alphanumeric and other keys for communicating information and/or command selections to the processors 702-706. Another type of user input device includes cursor control, such as a mouse, a trackball, or cursor direction keys for communicating direction information and command selections to the processors 702-706 and for controlling cursor movement on the display device.

System 700 may include a dynamic storage device, referred to as main memory 716, or a random access memory (RAM) or other computer-readable devices coupled to the processor bus 712 for storing information and instructions to be executed by the processors 702-706. Main memory 716 also may be used for storing temporary variables or other intermediate information during execution of instructions by the processors 702-706. System 700 may include a read only memory (ROM) and/or other static storage device coupled to the processor bus 712 for storing static information and instructions for the processors 702-706. The system set forth in FIG. 7 is but one possible example of a computer system that may employ or be configured in accordance with aspects of the present disclosure.

According to one embodiment, the above techniques may be performed by computer system 700 in response to processor 704 executing one or more sequences of one or more instructions contained in main memory 716. These instructions may be read into main memory 716 from another machine-readable medium, such as a storage device. Execution of the sequences of instructions contained in main memory 716 may cause processors 702-706 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available through a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 716, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed is:

1. A method for travel assistance, the method comprising:
receiving, at a travel assistance system and from a mobile device, a request for a travel assistance response from the travel assistance system, the request comprising a geographic location of the mobile device;
obtaining, from one or more databases, secondary data associated with the geographic location of the mobile device and demographic data of a user of the mobile device;
calculating, based on the secondary data, a risk assessment score;
determining, based on the risk assessment score, a type of the travel assistance response; and
transmitting one or more instructions to a computing device in communication with the travel assistance system and corresponding to the type of the travel assistance response, the one or more instructions causing the computing device to execute the type of the travel assistance response.

2. The method of claim 1 wherein the secondary data obtained from the one or more databases comprises at least one of an indication of a weather condition at the geographic location, a history of crime-related events at the geographic location, a safety alert associated with the geographic location, or data of a local service provider.

3. The method of claim 1, further comprising:
obtaining additional secondary data from the mobile device, the additional secondary data comprising at least one of a health condition of a user of the mobile device, an identifier of the mobile device, or inputs provided to the mobile device.

4. The method of claim 3, further comprising:
obtaining, based on a unique identifier associated with the mobile device, a user profile from a database of user profiles, the obtained user profile comprising at least one user preference for the type of the travel assistance response.

5. The method of claim 4 wherein calculating the risk assessment score comprises:
assigning a risk score to each of the secondary data associated with the geographic location and the user profile; and
calculating an average of the assigned risk scores to each of the secondary data and the user profile.

6. The method of claim 1 wherein determining the type of the travel assistance response comprises:
determining a type of travel assistance vehicle associated with the type of the travel assistance response;
obtaining one or more specifications of travel assistance vehicles in a fleet of available travel assistance vehicles; and
associating the one or more specifications of travel assistance vehicles with the type of the travel assistance response, wherein the one or more instructions comprise a route to the geographic location of the mobile device to cause the travel assistance vehicle to be dispatched to the geographic location.

7. The method of claim 6, further comprising:
determining a travel assistance area corresponding to the geographic location of the mobile device, the travel assistance area associated with the type of the travel assistance response.

8. The method of claim 7, further comprising:
determining a geographic location of one or more travel assistance vehicles corresponding to the type of travel assistance vehicle is within the travel assistance area; and
ranking the one or more travel assistance vehicles.

9. The method of claim 8 wherein ranking the one or more travel assistance vehicles is based on the secondary data associated with the geographic location, the type of the travel assistance response, and a user profile.

10. The method of claim 1 wherein the request for the travel assistance response comprises a user identifier, the method further comprising:
authenticating the user identifier with a database of user identifiers of the travel assistance system.

11. The method of claim 1, further comprising:
executing a machine-learning algorithm to generate a travel assistance response model, the travel assistance response model configured to determine the travel assistance response based at least on an input of the secondary data associated with the geographic location of the mobile device.

12. The method of claim 1, further comprising:
establishing a communication session with the mobile device, the communication session comprising transmitting at least one of routing information to a destination, instructions to a user of the mobile device, or a communication from a travel assistance personnel.

13. The method of claim 6, further comprising:
establishing a communication session with a communication system of the travel assistance vehicle, the communication system of the travel assistance vehicle comprising at least one of a video communication system or an audio communication system.

14. A travel assistance system comprising:
a processing device in communication with a network and receiving a request for a travel assistance response from a mobile device, the request for the travel assistance response comprising at least a geographic location and an identifier of a user of the mobile device; and
a non-transitory database for storing one or more user profiles associated with users of the travel assistance system;
wherein the processing device executes one or more instructions that cause the processing device to perform the operations of:
obtaining, from one or more third-party databases, secondary data associated with the geographic location of the mobile device;
calculating, based on the geographic location and the secondary data associated with the geographic location of the mobile device obtained from one or more third-party databases, a risk assessment score and a type of the travel assistance response;
determining, based on the risk assessment score and the type of the travel assistance response, a type of travel assistance vehicle for responding to the travel assistance response; and
transmitting one or more instructions, to a computing device of a travel assistance vehicle corresponding to the type of travel assistance vehicle, to dispatch the travel assistance vehicle to the geographic location of the mobile device, the one or more instructions comprising a route to the geographic location.

15. The travel assistance system of claim 14 wherein the secondary data obtained from the one or more third-party databases comprises at least one of an indication of a weather condition at the geographic location, a history of crime-related events at the geographic location, a safety alert associated with the geographic location, or data of a local service provider.

16. The travel assistance system of claim 14 wherein the one or more instructions further cause the processing device to perform the operations of:
obtaining additional secondary data from the mobile device, the additional secondary data comprising at least one of a health condition of a user of the mobile device, an identifier of the mobile device, or inputs provided to the mobile device via an input device.

17. The travel assistance system of claim 14 wherein the processing device and the non-transitory database comprise a virtual machine hosted on at least one server of a network.

18. The travel assistance system of claim 14 wherein the one or more instructions further cause the processing device to perform the operations of:
obtaining, based on a unique identifier associated with the mobile device, a user profile from the non-transitory database;
determining a travel assistance area corresponding to the geographic location of the mobile device, the travel assistance area associated with the type of requested travel assistance response;
determining a geographic location of one or more travel assistance vehicles corresponding to the type of travel assistance vehicle is within the travel assistance area; and
ranking the one or more travel assistance vehicles, wherein ranking the one or more travel assistance vehicles is based on the secondary data associated with the geographic location.

19. One or more tangible non-transitory computer-readable storage media storing computer-executable instructions for performing a computer process on a server of a network, the computer process comprising the method of:
receiving, at the server and from a mobile device, a request for a travel assistance response from a travel assistance system, the request comprising a geographic location of the mobile device;
obtaining, from one or more third-party databases, secondary data associated with the geographic location of the mobile device;
calculating, based on the secondary data associated with the geographic location of the mobile device, a risk assessment score for the travel assistance response;
determining, based on the risk assessment score, a type of travel assistance vehicle for responding to the travel assistance response; and
transmitting one or more instructions, to a computing device of a travel assistance vehicle corresponding to the type of travel assistance vehicle, to dispatch the travel assistance vehicle to the geographic location of the mobile device, the one or more instructions comprising a route to the geographic location.

20. The one or more tangible non-transitory computer-readable storage media of claim 19 storing computer-executable instructions for performing the computer process further comprising:
assigning a risk score to each of the secondary data associated with the geographic location; and
calculating an average of the assigned risk scores to each of the secondary data to determine the risk assessment for the travel assistance response.
